(19) United States
(12) Patent Application Publication
(10) Pub. No.: US 2017/0286090 A1
(43) Pub. Date: Oct. 5, 2017

(54) HIGH PERFORMANCE MOBILE DEVICE FLASHING

(71) Applicant: MICROSOFT TECHNOLOGY LICENSING, LLC, Redmond, WA (US)

(72) Inventors: Robert Yu Zhu, Bellevue, WA (US); Ying N. Chin, Bellevue, WA (US); Dejun Zhang, Redmond, WA (US); Bin Wang, Bellevue, WA (US); Satyendra Bahadur, Yarrow Point, WA (US); Xuejun Chen, Redmond, WA (US); Haifeng Zheng, Redmond, WA (US); Pengxiang Zhao, Bellevue, WA (US)

(21) Appl. No.: 15/087,863

(22) Filed: Mar. 31, 2016

(51) Int. Cl. G06F 9/445; H04L 29/08

(52) U.S. Cl. CPC G06F 8/665; H04L 67/34

(57) ABSTRACT

Systems, methods and storage devices are configured for facilitating flashing of mobile devices. Some disclosed embodiments include burst flashing mobile devices in such a way as to facilitate a reduction in time required for tethering the mobile devices that are tethered during the flashing session and by transmitting all data required for flashing the device to the volatile memory of the mobile device and de-tethering the mobile device prior to all of the transmitted data being written to the non-volatile memory of the mobile device.

### BACKGROUND

### Background and Relevant Art

Mobile phones and other mobile devices are configured with software, such as Operating System (OS) software, modem communication software and other device specific software that is typically installed within a hard drive or other non-volatile storage location, such as an eMMC (embedded multimedia card), during a process called ‘flashing.’

Device flashing can be performed by an OEM (Original Equipment Manufacturer) prior to distribution, by an intermediary vendor subsequent to distribution, and/or by end users.

During flashing, a mobile device is physically tethered to a computing system, referred to herein as a workbench or workbench computing system, which contains the software to be installed on the mobile device. A USB cable is typically used to physically tether the mobile device to the workbench during flashing. It is also possible to use a USB hub to physically tether multiple devices to a single workbench for concurrent flashing of multiple devices during a single flashing session.

The software to be installed on the device(s) is first formatted into an appropriate image file and is transmitted through the physical tether to the device. There are various file formats that can be used for transmitting software images during flashing, such as a .WIM (Windows Image) format, a .VHD/.VHDX (Virtual Hard Disk) format, a .FFU (Full Flash Update) format, and other formats.

The flashed images (irrespective of file formatting) are typically segmented prior to transmission and are incrementally transmitted and written to the hard drive, eMMC, or other persistent storage of the device during a flashing session. In such instances, a subsequent segment image/file is only transmitted upon receiving confirmation that the previous segment has been successfully written to the persistent storage of the device (e.g., the eMMC of the device). If a particular segment is not successfully transmitted and/or written to the persistent storage of the device, due to one or more transmission or writing errors, that particular segment will be retransmitted.

Upon fully installing each of the transmitted segments of the image file to the persistent storage of the device, the device can be de-tethered from the workbench computing system and a new/next device can be tethered and flashed from the workbench. The tether time that necessarily occurs during flashing, represents a limitation experienced by OEMs and vendors in efficiently flashing multiple devices.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The disclosed embodiments include systems, methods and storage devices configured for facilitating flashing of mobile devices. Some disclosed embodiments include burst flashing of mobile devices in such a way as to facilitate a reduction in time required for tethering the mobile devices that are tethered during the flashing session and by transmitting all data required for flashing the device to the volatile memory of the mobile device and de-tethering the mobile device prior to all of the transmitted data being written to the non-volatile memory of the mobile device.

In some instances, a workbench computing system is configured for burst flashing a mobile device. This is accomplished, for example, by the workbench computing system identifying a payload to be flashed to a non-volatile memory of a mobile device and segmenting the payload into a full set of payload segments for transmission to a mobile device and that is tethered to the workbench computing system. The workbench computing system sends the full set of payload segments to the mobile device which is tethered to the workbench computing system, wherein the full set of payload segments is transmitted to the mobile device with one or more payload transmissions. The full set of payload segments is initially written to volatile memory of the device, concurrently or in stages, prior to being written to the non-volatile memory of the mobile device. Then, the workbench computing system obtains confirmation that the full set of payload segments has been received by the mobile device, while at least some portion of the full set of payload segments still remains within the volatile memory of the mobile device. Once all of the payload segments have been transmitted to the mobile device, the mobile device can be de-tethered from the workbench computing system, even while one or more of the segments remain within the volatile memory of the device and prior to the full set of payload segments having been written to the non-volatile memory of the mobile device.

From the perspective of the mobile device during burst flashing, the mobile device receives the full set of payload segments to be flashed from the workbench computing system while the mobile device is tethered to the workbench computing system. Then, the mobile device writes the full set of payload segments to volatile memory of the mobile device while the mobile device is still tethered to the workbench computing system. Thereafter, the payload segments are written from the volatile memory to the non-volatile memory of the mobile device. Confirmation is made by the mobile device that the full set of payload segments has been received by the mobile device prior to writing all of the full set of payload segments to the non-volatile memory of the mobile device. One or more receipt acknowledgements are also sent, in some embodiments, to the workbench computing system corresponding to receipt of the full set of payload segments, and prior to the full set of payload segments being written to the non-volatile memory of the mobile device, for providing notice that the mobile device can be de-tethered from the workbench computing system (even prior to all of the segments having been written to the non-volatile memory of the mobile device).

In some embodiments, a method for flashing mobile devices includes tethering a mobile device to a workbench and using the workbench computing system to access a payload to be flashed to non-volatile memory of the mobile device. The method also includes using the workbench computing system to segment the payload into a full set of payload segments that are transmitted by the mobile device to the mobile device in one or more payload transmissions. Each of the payload segments is initially written to volatile memory of the device, prior to being written to the non-volatile memory of the mobile device. This method also includes obtaining a confirmation that the full set of payload segments has been received by the mobile device, while at least some portion of the full set of payload segments still remains within the volatile memory of the mobile device, and prior to the full set of payload segments being written to the non-volatile memory of the mobile device. Finally, the mobile device is de-tethered from the workbench and, in some instances, prior to each of the payload segments being written to the non-volatile memory of the mobile device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment that includes a workbench computing system that is connected to at least one mobile device that is being flashed by the workbench computing system;

FIG. 2 illustrates a computing environment that includes a mobile device and a plurality of files that are first converted into a VHD file and subsequently converted into a FFU file for flashing to a mobile device;

FIG. 3 illustrates one embodiment of a FFU file different portions of the FFU file;

FIG. 4 illustrates a computing environment that includes mobile device and a plurality of files that are configured for flashing to the mobile device as individual file or file segments;

FIG. 5 illustrates a computing environment that includes a workbench computing system and a mobile device having RAM and EMMC, wherein a file image segment is transferred from the workbench computing system to the mobile device during a flashing process;

FIG. 6 illustrates a computing environment that includes a workbench computing system and a mobile device having RAM and EMMC, wherein a file image segment is transferred from the workbench computing system to the mobile device during a flashing process and in which a notice or acknowledgement is generated to acknowledge receipt of the image segment by the mobile device;

FIG. 7 illustrates a flowchart with acts corresponding to methods for burst flashing one or more mobile device(s), from the perspective of a flashing workbench computing system;

FIG. 8 illustrates a flowchart with acts corresponding to methods for burst flashing a mobile device, from the perspective of a user and workbench; and

FIG. 9 illustrates another flowchart with acts corresponding to methods for burst flashing a mobile device from the perspective of the mobile device.

### DETAILED DESCRIPTION

The disclosed embodiments include systems, methods and storage devices for facilitating flashing of mobile devices in a manner that is referred to herein as ‘burst flashing.’

Burst flashing is performed, according to some embodiments, in such a manner as to facilitate a reduction in time required for tethering of mobile devices that are being flashed, at least relative to currently known slower flashing techniques. This represents a significant technical benefit in the industry of mobile device manufacture and distribution. For instance, in some embodiments, the disclosed burst flashing can significantly improve the efficacy and speed of flashing mobile devices.

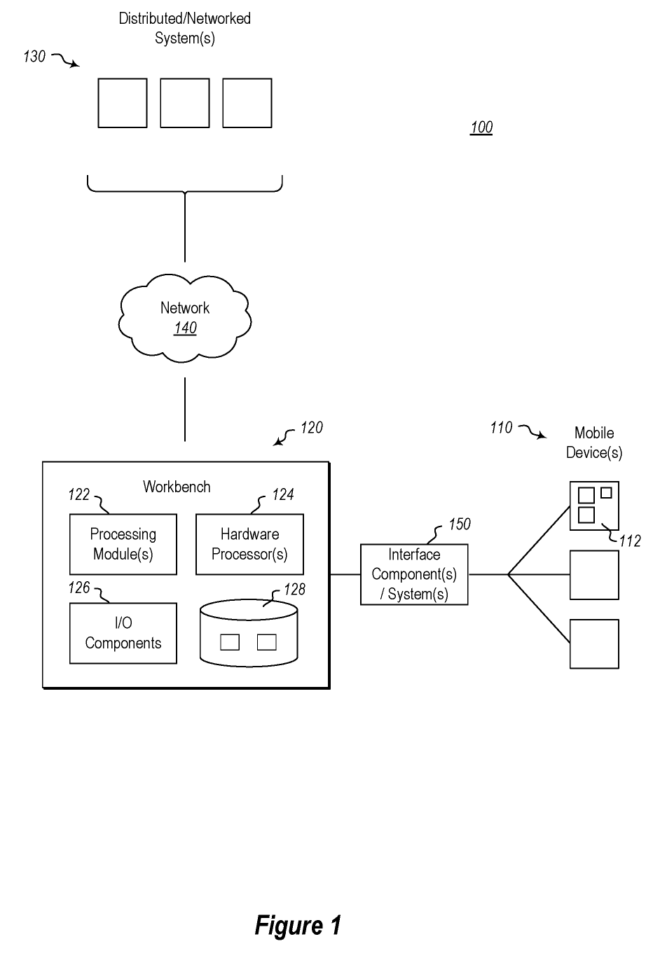

FIG. 1 illustrates a computing environment in which one or more mobile device(s) 110 are burst flashed by a workbench computing system 120. The mobile device(s) 110 include one or more mobile phones, tablets, phablets, watches, wearable computing devices and/or any other portable device having an eMMC and/or other non-volatile memory capable of being flashed/written to.

This workbench computing system can be an isolated and stand-alone computing system or an integrated computing system that is connected to one or more distributed systems 130 through a corresponding network 140. These distributed systems 130 can be remotely located from the workbench computing system 120 or locally located relative to the workbench computing system 120.

The bursting workbench computing system 120 is physically tethered to the mobile device(s) 110 during the flashing session with one or more interface component(s)/system(s), such as a USB cable or another similar interface cable between the workbench 120 and the mobile device(s) 110. In some instances, one or more an intermediary USB hubs and/or other computing components are connectively positioned between the workbench 120 and the mobile device(s) with the USB cable.

The workbench computing system 120 includes various components for facilitating the flashing that is disclosed herein. For instance, the computing system 120 includes one or more processing module(s) 122 having stored computer-executable instructions that are executable by one or more hardware processor(s) 124 for implementing the methods and other functionality disclosed herein. The workbench computing system 120 also includes I/O components such as displays, keyboards, and UI interfaces that are configured to receive input and to generate output.

The workbench computing system 128 also includes one or more storage device 128 that includes one or more volatile and/or non-volatile memories. The storage device 128 stores processing module(s), interfaces and other stored data that is used for performing the flashing that is disclosed herein. This stored data also includes the actual files/images that are transmitted to the mobile devices during the flashing, as well as interfaces that are operable to monitor progress of the flashing and that otherwise facilitate interfacing of the workbench 120 with the mobile device(s) 110 and other systems disclosed herein.

Each of the mobile devices 110 being flashed is also configured with corresponding I/O components, processing modules, hardware processors, and storage devices for facilitating the flashing that is disclosed herein. For instance, the mobile devices 110 include communication components for communicating with the workbench 120, processing components for reading and writing data (including the flashed images), volatile memory (e.g., RAM), non-volatile memory (e.g., eMMC) and so forth. While there may be any number of components included within the mobile device(s) 110, these components are collectively illustrated as the three boxes of mobile device 112.

In some embodiments, the mobile devices are pre-configured with a suitable Basic Input/Output System (BIOS) or Unified Extensible Firmware Interface (UEFI) that is capable of facilitating USB discovery and data transfer and writing of received data to the non-volatile storage of the mobile device. When the mobile devices are not preconfigured with suitable BIOS or UEFI, then the disclosed methods further include installing the BIOS or UEFI onto the mobile device prior to the flashing session or as part of the flashing session.

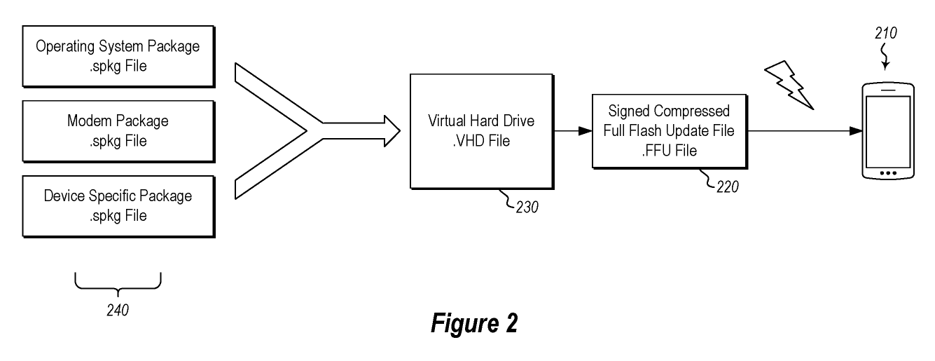

During flashing, one or more files are formatted into an appropriate image format and transmitted through the USB tether and/or other intermediary components to the mobile device(s) 110. Transfer of an image is further illustrated with respect to FIG. 2.

As shown in FIG. 2, a mobile device 210 is flashed with a signed and compressed Full Flash Update File (.FFU file) 220. The FFU file 220 is a specialized and known type of image that is used for transmitting installation files to a mobile device. The signing and/or encrypting of the FFU file is performed with the OEM certificate and/or another certificate that is usable to prevent malicious software from being installed on the mobile device 210. For instance, the mobile device is configured to verify the certificate of a received image file matches a known certificate/key prior to writing the received data to non-volatile memory. This is particularly important when the image file includes critical system software. In some embodiments, the FFU file includes OS software and device specific software, such as modem communication software.

In some instances, the FFU file 220 is compressed prior to being transmitted to the mobile device although, this is not required. In some instances, the FFU file comprises a digitally signed and compressed version of a Virtual Hard Drive file (.VHD file) which is composed of one or more separate .spkg files 240, such as the illustrated operating system package file, the modem package file, or another device specific package file that is executable by the hardware/processor(s) of the mobile device 210.

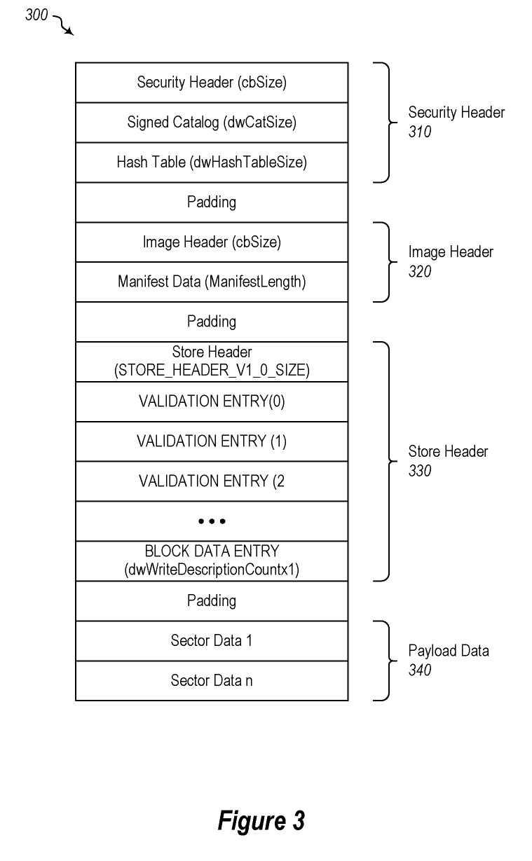

FIG. 3 illustrates one example of a FFU file 300, which includes a security header portion 310, an image header portion 320, a store header portion 330 and a payload data portion 340. The security header 310 is used to validate and authenticate credentials of the image data. The image header 320 is used to identify the type of image data and manifest tracking information. The store header 330 is used to validate specific entries of the data to be installed and the payload data 340 comprises the data that is being installed.

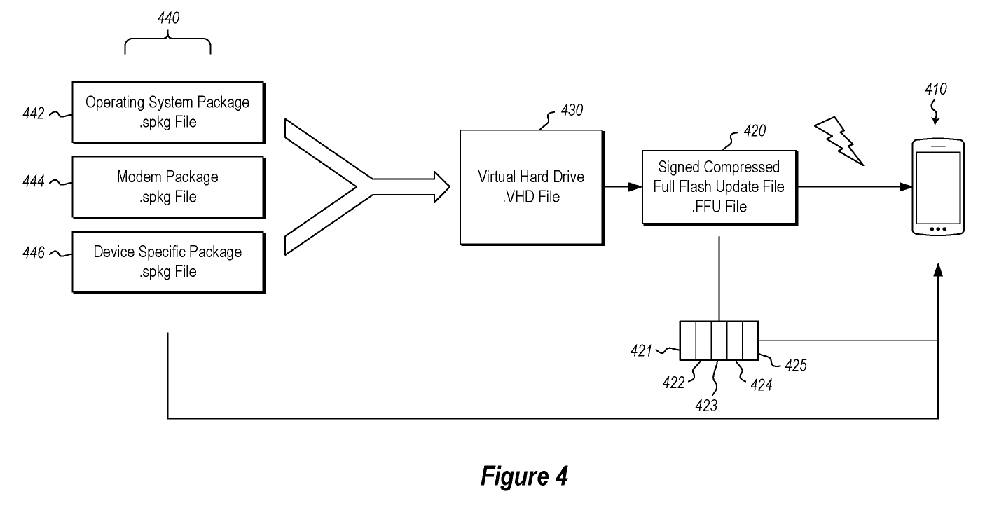

FIG. 4 illustrates how, in some embodiments, the image file is segmented during the flashing session prior to being transmitted to the mobile device 410. For instance, FFU file 420 is illustrated as being segmented into five (5) individual segments 421, 422, 423, 423 and 425. However, it will be appreciated that the file 420 can also be segmented into other quantities of two or more segments. The image segments are transmitted in a predetermined sequence/series to the mobile device 410 from the workbench computing system and/or USB hub. According to some instances, each of these segments is individually signed by the OEM certificate prior to the transfer. The size and quantity of the segments is also identified and stored in a table or other data structure. This information is used, in some instances, for tracking and confirming successful transmission of the segments to the volatile storage of the mobile device, as described in more detail below.

As suggested above, the operating system .spkg file 442, the modem .spkg file 444 and/or other device specific .spkg file(s) 446 can be converted into a single consolidated .VHD file 430 prior to being digitally signed and converted into a corresponding FFU file 420 that is later segmented. However, in some alternative embodiments, the specific files 440 are individually or collectively transmitted to the mobile device 410, as whole files and/or as segmented files, without first being converted into a VHD file and/or FFU image file format.

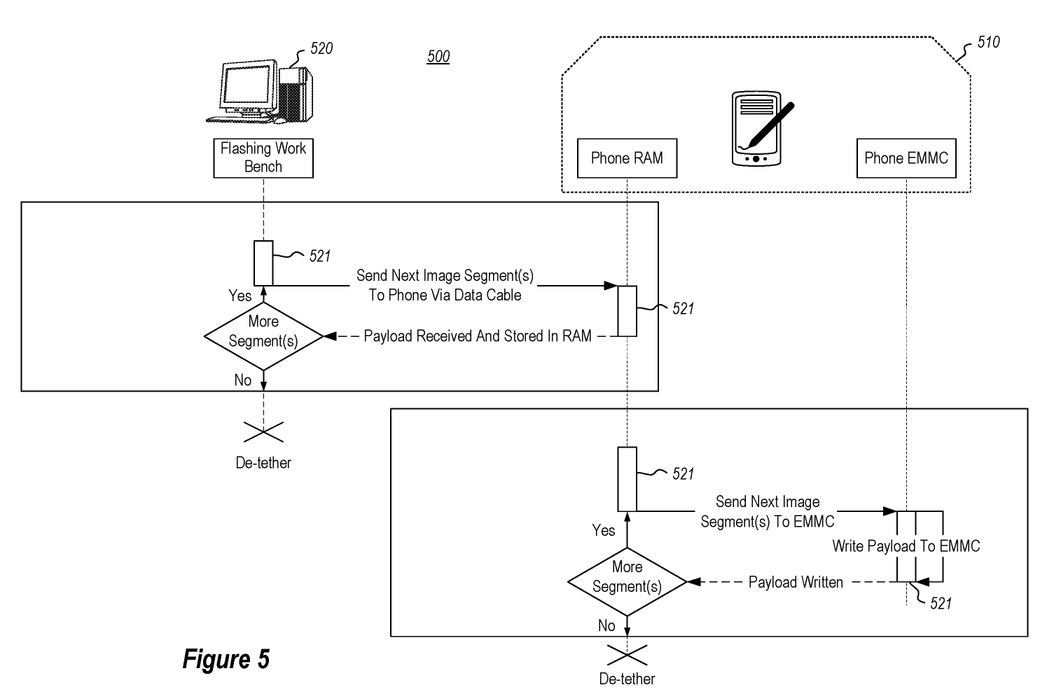

Attention will now be directed to FIG. 5, which illustrates how, according to some embodiments, burst flashing is accomplished. In this example, the flashing workbench 520 sends one or more image segment 521 (or whole file) to a mobile device 510 that is tethered to the workbench 520 with a data cable (e.g., USB cable). Once the mobile device 510 receives the segment(s) 521 and/or upon writing the segment(s) to RAM, the mobile device 510 generates an acknowledgment of receipt. This acknowledgement may include any identifier information extracted from the segment(s), such as the image header information, and/or that is inferred from the segment(s) (e.g., size).

Once the workbench 520 receives this acknowledgment, and if one or more additional segment(s) remain enqueued for flashing to the mobile device 510, the workbench sends the next segment(s) in queue to the mobile device 510. Importantly, the transmission of the next segment(s) occurs prior to any acknowledgement of the segment(s) being written to non-volatile storage and, in some instances, prior to the segment(s) even being written to the non-volatile storage. This facilitates transmission of the next segment(s) in queue from the workbench without having to wait for the previous segments to be written to non-volatile storage. The mobile device 510 can then be de-tethered from the workbench as soon as acknowledgement is made that the mobile device 510 has received the last segment(s) to be flashed.

The mobile device 510 writes the received segment(s) 521 to non-volatile storage (e.g., the eMMC) in a corresponding sequence, as reflected by the computing environment/flow of FIG. 5, at any appropriate time after being received. In some instances, the mobile device 510 completes the writing/flashing of all or some of the segment(s) to the non-volatile storage subsequent to the mobile device 510 being de-tethered from the workbench 520.

The foregoing process, as further described herein, is generally referred to as ‘burst flashing.’ It will be appreciated that this ‘burst flashing’ can significantly reduce the time that is required to keep mobile devices tethered during a flashing session and can, thereby, expedite the availability of the workbench and USB cable for flashing a ‘next’ device and to, thereby, increase overall flashing throughput of a workbench.

A specific example will now be provided to illustrate the efficiency gains that can be accomplished with burst flashing. In this example, a 2000 Mbyte image is flashed from the workbench to the mobile device through a USB data cable. The transfer rate of the USB cable is 40 Mbytes/second and the eMMC write performance of the mobile device is 10 Mbytes/second. Accordingly, the total transfer time of the image to the mobile device is about 50 seconds (2000 Mbytes/40 Mbytes/sec) and the total write time for writing the image to the eMMC non-volatile storage is 200 seconds (2000 Mbytes/10 Mbytes/sec).

In traditional flashing systems, the transfer and writing of the image segments is discontinuous, such that the total flashing time is greater than either the total transfer time or the total write time. For instance, in traditional flashing, a workbench will incrementally transmit a next image segment to a mobile device only upon verifying a successful write of a preceding segment to the eMMC of the mobile device. The mobile device is also only de-tethered upon verifying that the last segment of the image file is successfully written to the eMMC. Accordingly, this type of traditional flashing would require at least 250 seconds to fully flash the 2000 Mbyte image to the eMMC, as described above, (e.g., (2000 Mbytes/40 Mbytes/sec)+(2000 Mbytes/10 Mbytes/sec)). This 250 seconds of tethering time is significantly more than the amount of tethering time that is required by implementing the burst flashing techniques described herein. For instance, according to some embodiments, the mobile device is able to be de-tethered immediately upon verifying that the image data has been transferred to the mobile device and/or is written to the volatile RAM of the mobile device. This would take approximately 50 seconds according to the foregoing example, or only about 20% of the time required by traditional flashing.

Efficiency gains can also be realized even for hybrid scenarios in which the mobile device remains tethered to the workbench until the image data is fully written to the eMMC, but in which the writing of the image data is triggered by and performed continuously upon receiving the first image segment, and without requiring the workbench to pause transmissions the subsequent segment(s) while waiting for the acknowledgement(s) regarding successful writes of the segment(s) to the eMMC. In this hybrid scenario, the workbench will transmit the image to the mobile device RAM substantially continuously, only pausing/waiting (if at all) for acknowledgement(s) that the mobile device has received and/or written the segment(s) to the volatile RAM of the mobile device.

In this hybrid scenario, it will take approximately 50 seconds to fully transfer the image data to the mobile device RAM and approximately 200 seconds to write the image from the RAM to the eMMC. However, since the writing to the eMMC was initiated upon receiving the first image into the RAM and performed continuously thereafter, the total time required to flash the image to the eMMC will only be approximately 200 seconds (e.g., the total write time), which is still significantly less than the 250 seconds that would be required when applying traditional flashing techniques.

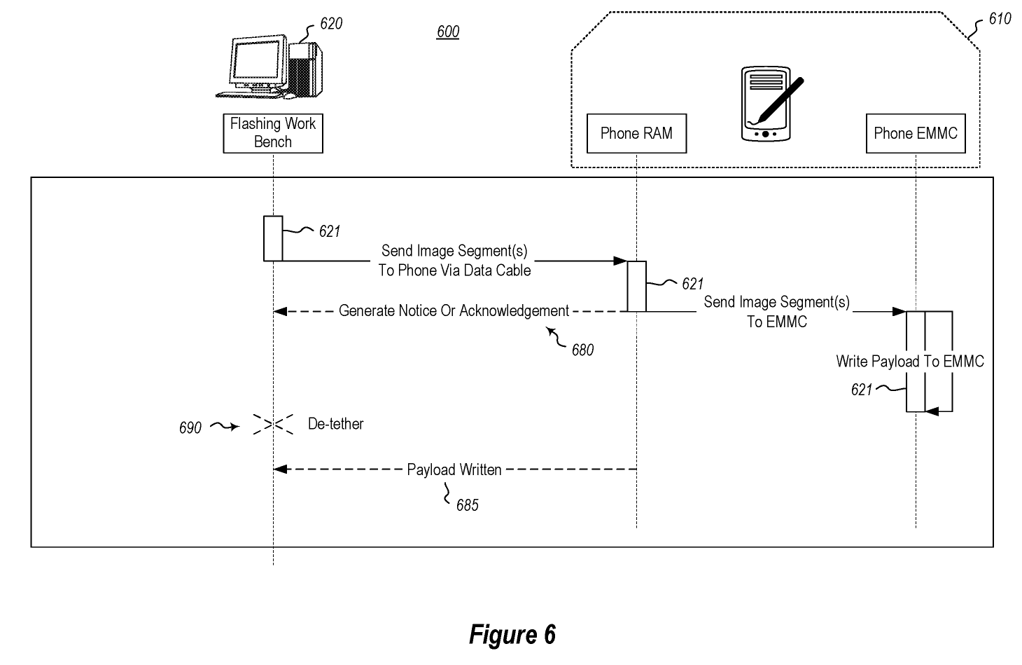

An illustration representing the hybrid burst flashing technique is shown in the computing environment/flow 600 of FIG. 6. As reflected, the flashing workbench 620 sends an image 621 to the RAM of the mobile device 610 and the mobile device immediately sends the image 621 from the RAM to the eMMC. A notice or acknowledgment 620 regarding receipt of the image is also generated by the mobile device 610. This acknowledgement can be used to trigger the transmission of the next segment(s) (if any remain to be transferred), as described above with regard to FIG. 5. The acknowledgement can also be used to trigger notice that the mobile device can be de-tethered 690, if no segment remains to be transferred, as also described in reference to the burst flashing technique of FIG. 5.

In the hybrid burst flashing technique, an acknowledgement of the image data having been fully written to the eMMC can also be used to notify the user that the mobile device 610 can be de-tethered 690.

The notification that the mobile device can be de-tethered from the workbench is generated and rendered at the mobile device (e.g., by rendering a visual and/or audio notice with display/speaker hardware of the mobile device), the workbench (e.g., by rendering a visual and/or audio notice with display/speaker hardware of the workbench) and/or at one of the intermediary component(s)/system(s) (150) or distributed system(s) (130) described above (e.g., by rendering a visual and/or audio notice with display/speaker hardware of the corresponding component(s)/system(s)). In one specific implementation, the notification is visual prompt displayed on an interface of the workbench that indicates the image data has been transferred and/or written to the mobile device. In another implementation, the notification is an interface display rendered at the mobile device. In yet another implementation, the notification is the illumination of a light on the USB cable hub or other physical component connected to the cables between the workbench and the mobile device.

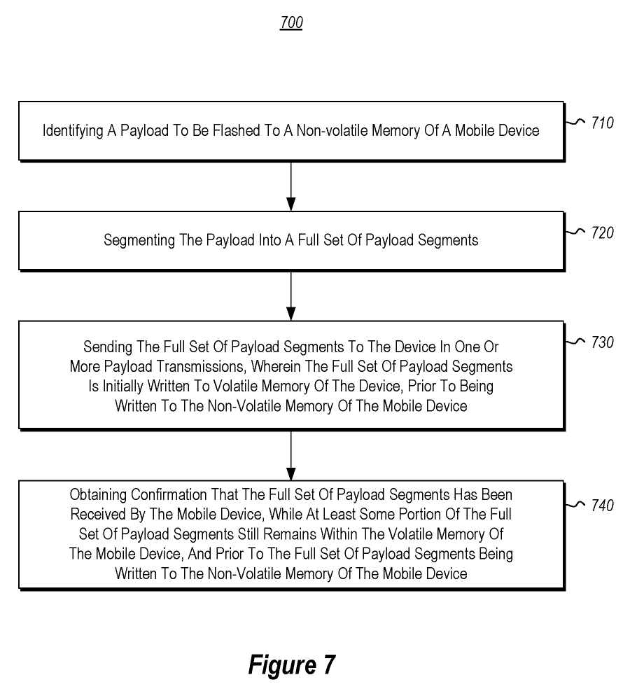

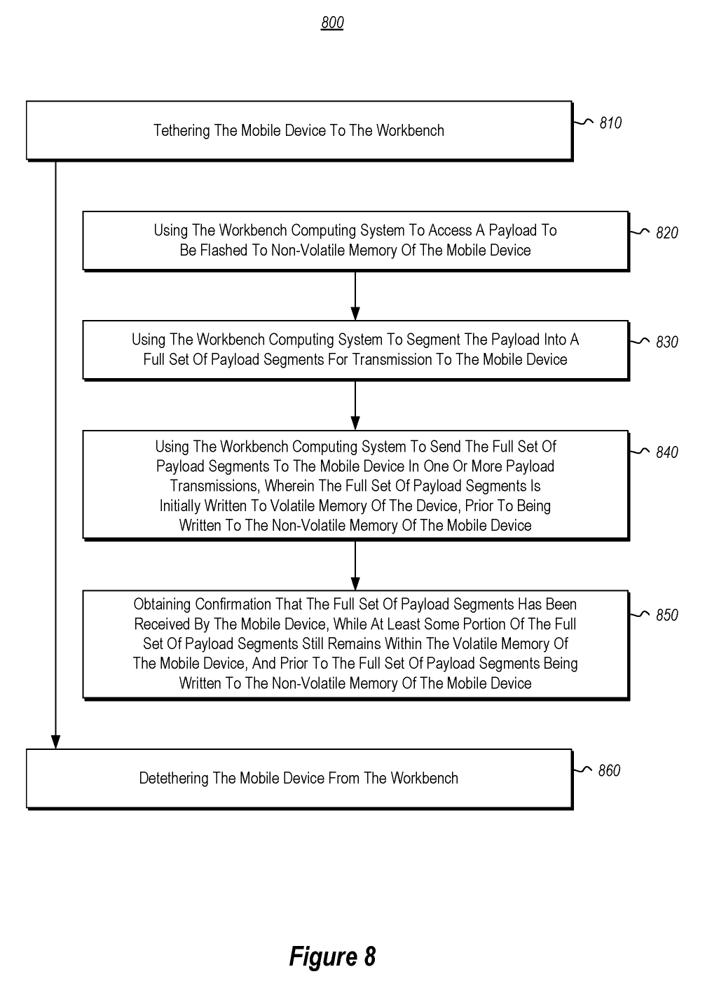

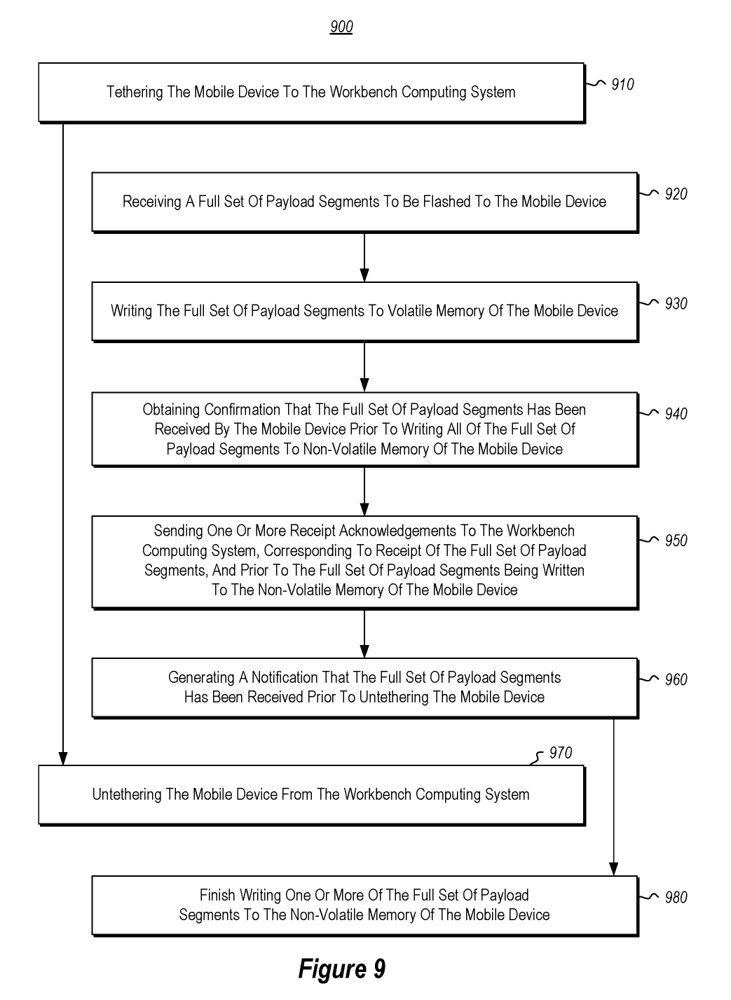

Attention will now be directed to FIGS. 7-9. FIG. 7 illustrates a flowchart 700 representing a method for burst flashing a mobile device from the perspective of the workbench computing system. FIG. 8 shows a flowchart 800 of a related method of burst flashing, recited from the perspective of the user/workbench. Finally, FIG. 9 illustrates yet another flowchart 900 related to methods for burst flashing from the perspective of the mobile device.

Each of the flowcharts 700, 800 and 900 includes a plurality of acts that are performed during implementation of the corresponding method(s). These acts are illustrated and sometimes described as being performed in a particular order. It will be appreciated, however, that no particular ordering is required for performing the acts of the disclosed methods or any of the other related methods covered by the scope of this disclosure, unless specifically stated, or unless specifically required because an act is dependent on another act being completed prior to the act being performed.

As illustrated in FIG. 7, some embodiments for burst flashing a mobile device include a workbench computing system identifying a payload to be flashed to a non-volatile memory of a mobile device (710). Although not required, the payload may be segmented into a full set of payload segments (720) for transmission to the mobile device, which is tethered to the workbench computing system during the transmission(s). Segmenting the payload can also include obtaining and/or formatting particular files (e.g., OS package files, modem package files and/or any other device specific files). In some instances, the formatting includes converting the files into VHD and FFU files and/or other image file formats prior to or subsequent to splitting the payload into individual segments. The formatting can also include digitally signing the segment(s) with an OEM certificate.

Next, the workbench computing system sends the full set of payload segments to the mobile device while the device remains tethered to the workbench computing system (730). As indicated previously, the full set of payload segments is transmitted to the mobile device in one or more payload transmissions (with one or more image segments being included within each payload transmission).

The full set of payload segments is initially written to volatile memory of the device, concurrently or in stages, prior to being written to the non-volatile memory of the mobile device.

After the payload is transmitted to the mobile device, the workbench computing system obtains confirmation that the full set of payload segments has been received by the mobile device (740). This confirmation occurs, in some instances, while at least some portion of the full set of payload segments still remains within the volatile memory of the mobile device (e.g., one or more segments are still maintained in RAM and prior to being fully written to the eMMC of the device). The confirmation may be determined by the workbench and/or by the mobile device. A corresponding notification is also generated, in some instances, as described above.

Importantly, once all of the payload segments have been transmitted to the mobile device, before or after the confirmation and notification, the mobile device can be de-tethered from the workbench computing system, even while one or more of the segments remain within the volatile memory of the device and prior to the full set of payload segments having been written to the non-volatile memory of the mobile device. As described above, this represents a substantial reduction in the time that would otherwise be required for tethering the device during traditional flashing. This is true, whether the device is immediately de-tethered, according to the optimized burst flashing technique, and even when the device is only de-tethered after the payload is fully written to the non-volatile storage (e.g., eMMC), according to the hybrid burst flashing technique.

FIG. 8 illustrates a related method that is recited from a user/workbench perspective and that further includes tethering and de-tethering the mobile device from the workbench. In this embodiment, the mobile device is tethered to the workbench (810) and the workbench is used to access (820), segment (830) and send (840) the full set of payload segments from the workbench to the mobile device, as previously described. Importantly, as also described, the full set of payload segments is initially written to volatile memory of the device prior to being written to the nonvolatile memory of the device. A confirmation of that the full set of payload segments has been received by the mobile device is also obtained prior to writing each segment of the full set of payload segments to the non-volatile memory of the mobile device (850). Finally, the mobile device is de-tethered from the mobile device, either before or after the confirmation and/or the writing of the full set of the payload to the non-volatile memory.

FIG. 9 illustrates a related method that is recited from the perspective of the mobile device. In this embodiment, the mobile device is tethered to the workbench (910) prior to receiving (920) and writing (930) the full set of payload segments at the volatile memory of the mobile device. A confirmation of the full set of payload segments has been received is also obtained by the mobile device (940). For instance, the mobile device may receive an acknowledgement from the workbench that all segments have been transmitted and/or by detecting a last segment from a received manifest and/or by detecting a total amount of data has been received that matches an indicated full image size and/or by receiving an explicit notification from the workbench that all indication that all transfer size of received data.

The mobile device will then send one or more receipt acknowledgements to the workbench computing system (950), corresponding to the receipt of the full set of payload segments (e.g., in response to the detected confirmation). This may also include sending separate receive receipts for each of the different image segments when they are received.

The confirmation is also used, in some embodiments, to trigger the generation of a notification (960) that is operable to notify a user that the full set of payload segments has been received by the mobile device and that it is safe to de-tether the mobile device. The mobile device is then de-tethered, when desired (970).

In some instances, the generation of a same and/or different user notification may also be triggered by verifying that the full set of payload segments has been written to at least the volatile memory of the mobile device (960). Accordingly, while act 980 is shown to follow act 960, it is also possible for act 980 to precede act 960. In some instances, other acts can also be performed in different ordering, as described above. Likewise, the disclosed methods can also include additional acts that are not explicitly illustrated. For instance, the one or more notification(s) that are generated are displayed at the mobile device, the workbench and/or another component, as described above, even though not explicitly illustrated.

As described above, the disclosed embodiments for burst flashing and hybrid burst flashing can be utilized to obtain significant savings in the time that is required for a mobile device to be tethered during flashing. Other advantages and technical benefits of the present disclosure are also evident from the foregoing description.

With regard to the foregoing disclosure and recited methods, it will be appreciated that the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A workbench computing system that implements a method for burst flashing a mobile device from a workbench computing system, workbench computing system comprising:
one or more processors; and
one or more storage device having stored computer-executable instructions which are executable by the one or more processors for causing the workbench computing system to perform the following:
the workbench computing system identifying a payload to be flashed to a non-volatile memory of a mobile device;
the workbench computing system segmenting the payload into a full set of payload segments for transmission to the mobile device;
the workbench computing system sending the full set of payload segments to the mobile device which is tethered to the workbench computing system, the full set of payload segments being transmitted in one or more payload transmissions, wherein the full set of payload segments is initially written to volatile memory of the device, prior to being written to the non-volatile memory of the mobile device;
the workbench computing system obtaining confirmation that the full set of payload segments has been received by the mobile device, while at least some portion of the full set of payload segments still remains within the volatile memory of the mobile device, and prior to the full set of payload segments being written to the non-volatile memory of the mobile device.

2. The workbench computing system of claim 1, wherein the mobile device is untethered from the workbench computing system prior to each payload segment within the full set of payload segments being written to the non-volatile memory of the mobile device, and wherein the at least some portion of the full set of payload segments is written to the non-volatile memory of the mobile device subsequent to the mobile device being untethered from the workbench.

3. The workbench computing system of claim 1, wherein the non-volatile memory of the mobile device is EMMC and the volatile memory of the mobile device is RAM.

4. The workbench computing system of claim 1, wherein the computer-executable instructions are further executable by the one or more processors for causing the workbench computing system to further perform:
the workbench computing system incrementally sending the full set of payload segments to the mobile device through a plurality of corresponding incremental transmissions; and
the workbench computing system receiving a receipt acknowledgement from the mobile device for each of the corresponding incremental transmissions.

5. The workbench computing system of claim 1, wherein the computer-executable instructions are further executable by the one or more processors for causing the workbench computing system to further perform:
the workbench computing system obtaining the confirmation that the full set of payload segments has been received by receiving an acknowledgment from the mobile device that a last incremental transmission of the incremental transmissions has been received by the mobile device.

6. The workbench computing system of claim 1, wherein the untethering occurs prior to any confirmation that the full set of payload segments have been written to the non-volatile memory of the device.

7. A method for burst flashing a mobile device from a workbench computing system, the method comprising:
receiving a full set of payload segments to be flashed to the mobile device, the full set of payload segments being received from the workbench computing system while the mobile device is tethered to the workbench computing system;
writing the full set of payload segments to volatile memory of the mobile device while the mobile device is tethered to the workbench computing system;
obtaining confirmation that the full set of payload segments has been received by the mobile device prior to writing all of the full set of payload segments to non-volatile memory of the mobile device; and
sending one or more receipt acknowledgements to the workbench computing system corresponding to receipt of the full set of payload segments and prior to the full set of payload segments being written to the non-volatile memory of the mobile device.

8. The method of claim 7, wherein the sending of the one or more receipt acknowledgments includes sending a separate receipt acknowledgement for each of a plurality of different incremental payload segments received by the mobile device.

9. The method of claim 7, wherein the method further includes sending the one or more receipt acknowledgements prior to completely writing the full set of payload segments to the non-volatile memory.

10. The method of claim 7, wherein the method further includes writing at least one or more of the full set of payload segments from the volatile memory of the mobile device to the non-volatile memory of the mobile device subsequent to the mobile device being untethered from the workbench.

11. The method of claim 7, wherein the method further includes generating a notification that the full set of payload segments has been received prior to untethering the mobile device.

12. The method of claim 11, wherein the method further includes rendering the notification at the mobile device.

13. The method of claim 11, wherein the method further includes transmitting the notification to the workbench computing system.

14. The method of claim 11, wherein the notification is a visual notification that is displayed at one or more of the mobile device or the workbench computing system.

15. The method of claim 7, wherein the obtaining the confirmation includes detecting a payload segment in the received full set of payload segments that includes an identifier that identifies the payload segment as a last payload segment of the full set of payload segments to be received.

16. The method of claim 7, wherein the obtaining the confirmation includes detecting the full set of payload segments received corresponds to a designated manifest of payload segments to be received.

17. The method of claim 7, wherein the method further includes, subsequent to the untethering, generating a confirmation that the full set of payload segments have been written to the non-volatile memory.

18. The method of claim 7, wherein the volatile memory includes RAM and the non-volatile memory includes EMMC.

19. A method for burst flashing a mobile device from a workbench computing system, the method comprising:
tethering the mobile device to the workbench
using the workbench computing system to access a payload to be flashed to non-volatile memory of the mobile device;
using the workbench computing system to segment the payload into a full set of payload segments for transmission to the mobile device;
using the workbench computing system to send the full set of payload segments to the mobile device in one or more payload transmissions, wherein the full set of payload segments is initially written to volatile memory of the device, prior to being written to the non-volatile memory of the mobile device;
obtaining confirmation that the full set of payload segments has been received by the mobile device, while at least some portion of the full set of payload segments still remains within the volatile memory of the mobile device, and prior to the full set of payload segments being written to the non-volatile memory of the mobile device; and
de-tethering the mobile device from the workbench.

20. The method of claim 1, wherein the untethering is performed prior to each payload segment within the full set of payload segments being written to the non-volatile memory of the mobile device, and wherein the at least some portion of the full set of payload segments is written to the non-volatile memory of the mobile device subsequent to the mobile device being untethered from the workbench.
